(19) United States
(12) Patent Application Publication
(10) Pub. No.: US 2025/0238170 A1
(43) Pub. Date: Jul. 24, 2025

(54) COMPUTER-READABLE STORAGE MEDIUM AND METHOD FOR PASSING PRINTER IDENTIFICATION INFORMATION FROM SUPPORT PROGRAM TO SPECIFIC APPLICATION PROGRAM

(71) Applicant: BROTHER KOGYO KABUSHIKI KAISHA, Nagoya (JP)

(72) Inventor: Hirokazu Sato, Nagoya (JP)

(21) Appl. No.: 19/014,301

(22) Filed: Jan. 9, 2025

(30) Foreign Application Priority Data
Jan. 19, 2024 (JP) 2024-006576

(51) Int. Cl. G06F 3/12

(52) U.S. Cl. CPC G06F 3/1203; G06F 3/1228; G06F 3/1257; G06F 3/126; G06F 3/1287

(57) ABSTRACT

A non-transitory computer-readable storage medium stores a support program supporting a generic print program standardly implemented with an operating system of an information processing device. The support program, when executed by a computer of the information processing device, causes the information processing device to, in a case where a first launch instruction to launch the support program has been received by the operating system, acquire printer identification information for identifying a particular printing device, and in a case where a second launch instruction to launch a specific application program incorporated in the information processing device has been received via a user interface of the information processing device, provide the specific application program with an instruction to launch the specific application program and the printer identification information. The printer identification information is used for the specific application program to select the particular printing device.

### REFERENCE TO RELATED APPLICATIONS

This application claims priority from Japanese Patent Application No. 2024-006576 filed on Jan. 19, 2024. The entire content of the priority application is incorporated herein by reference.

### BACKGROUND ART

In recent years, a technology has been put to practical use in which a printer is controlled by an OS-standard generic print program that forms part of an OS incorporated in an information processing device, without using a printer driver provided by a printer vendor. In this technology, in response to detecting a printer, the OS associates the detected printer with the OS-standard generic print program. Thereafter, in response to receiving a print instruction to cause the printer to perform printing, the information processing device generates print data by the OS-standard generic print program, without using the printer driver provided by the printer vendor. This makes it possible to cause the printer to perform printing via the OS-standard generic print program.

Various application programs (hereinafter referred to as “applications”) configured to use printers have been known, as well as an application configured to manage a plurality of applications. For instance, an information processing device has been disclosed that includes an application manager to manage applications and a printer manager to manage printers and is configured to display a current status of a printer corresponding to a selected application.

### SUMMARY

As described above, there is a known technology to manage printers and applications in association with each other. Even in an environment where the OS-standard generic print program is used, it is desirable to manage applications that are configured to use printers. However, the OS-standard generic print program is not provided with an application-related interface, and therefore there is room for improvement in this regard.

According to aspects of the present disclosure, a non-transitory computer-readable storage medium is provided, which stores computer-readable instructions that are executable by a computer of an information processing device. The computer-readable instructions include a support program configured to support a generic print program standardly implemented with an operating system of the information processing device. The support program is further configured to, when executed by the computer, cause the information processing device to, in a case where a first launch instruction to launch the support program compatible with a particular printing device has been received by the operating system, acquire printer identification information for identifying the particular printing device. The support program is further configured to, when executed by the computer, cause the information processing device to, in a case where a second launch instruction to launch a specific application program has been received via a user interface of the information processing device, provide the specific application program with a launch instruction to launch the specific application program and the acquired printer identification information, the specific application program being configured to receive selection of a printing device and receive a print instruction to cause the selected printing device to perform printing, the printer identification information being used for the specific application program to select the particular printing device.

According to aspects of the present disclosure, further provided is a non-transitory computer-readable storage medium storing computer-readable instructions that are executable by a computer of an information processing device. The computer-readable instructions include a program set that includes a first program and a second program. The first program is a support program configured to support a generic print program standardly implemented with an operating system of the information processing device. The second program is a specific application program configured to receive selection of a printing device and receive a print instruction to cause the selected printing device to perform printing, The first program is further configured to, when executed by the computer, cause the information processing device to, in a case where a first launch instruction to launch the first program compatible with a particular printing device has been received by the operating system, acquire printer identification information for identifying the particular printing device. The first program is further configured to, when executed by the computer, cause the information processing device to, in a case where a second launch instruction to launch the second program has been received via a user interface of the information processing device, provide the second program with a launch instruction to launch the second program and the acquired printer identification information. The printer identification information is used for the second program to select the particular printing device. The second program is further configured to, when executed by the computer, cause the information processing device to, in a case where the second program has been launched in response to the second launch instruction being received by the first program, and has received the printer identification information from the first program, search for the particular printing device using the printer identification information, and select the particular printing device in response to the particular printing device being found by the search.

According to aspects of the present disclosure, further provided is a method implementable by a computer executing computer-readable instructions on an information processing device. The computer-readable instructions include a support program configured to support a generic print program standardly implemented with an operating system of the information processing device. The support program is configured to, when executed by the computer, cause the information processing device to perform the method. The method includes performing, in a case where a first launch instruction to launch the support program compatible with a particular printing device has been received by the operating system, acquiring printer identification information for identifying the particular printing device. The method further includes performing, in a case where a second launch instruction to launch a specific application program has been received via a user interface of the information processing device, providing the specific application program with a launch instruction to launch the specific application program and the acquired printer identification information. The specific application program is configured to receive selection of a printing device and receive a print instruction to cause the selected printing device to perform printing. The printer identification information is used for the specific application program to select the particular printing device.

### BRIEF DESCRIPTION OF DRAWINGS

FIG. 1 is a block diagram schematically showing an electrical configuration of a personal computer (hereinafter referred to as a “PC”) connected with a printer.

FIG. 2 is a sequence diagram showing an example of an application management procedure.

FIGS. 3A and 3B show examples of a device management screen.

FIG. 4 shows an example of a detailed management screen.

FIG. 5 shows an example of an offline notification screen.

FIG. 6 shows an example of an application selection screen.

FIG. 7 is a sequence diagram showing an example of an application startup procedure.

FIG. 8 shows an example of a parameter application selection screen.

FIG. 9 shows an example of a startup screen.

FIG. 10 is a sequence diagram showing an example of a print execution procedure.

FIG. 11 is a sequence diagram showing an example of an application startup procedure.

FIG. 12 shows an example of a setting reflection selection screen.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.” The same applies to a case where there are three or more selectable elements to consider.

A detailed explanation will be provided below of a personal computer (hereinafter referred to as a “PC”) using a support program and a program set in a first illustrative embodiment according to aspects of the present disclosure, with reference to the relevant accompanying drawings.

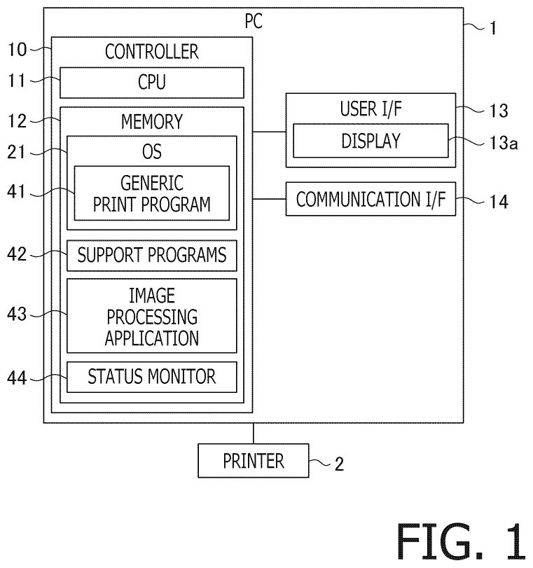

As shown in FIG. 1, a PC 1 of the first illustrative embodiment has a controller 10 that includes a CPU 11 and a memory 12. The PC 1 may be an example of an “information processing device” according to aspects of the present disclosure. The CPU 11 may be an example of a “computer” according to aspects of the present disclosure. The PC 1 further includes a user interface (hereinafter referred to as a “user I/F”) 13 and a communication interface (hereinafter referred to as a “communication I/F”) 14, which are electrically connected with the controller 10. The “controller 10” in FIG. 1 is a collective term for hardware and software used to control the PC 1, and may not necessarily represent a single hardware element actually existing in the PC 1.

The CPU 11 of the PC 1 is configured to perform various processes according to programs read from the memory 12 and based on user operations. The memory 12 stores various types of data and various application programs (hereinafter referred to as “applications”). The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes a display 13a that is hardware configured to display screens to provide information to the user, and hardware configured to receive user operations. The user I/F 13 may have a combination of the display 13a configured to display information (i.e., having a display function), and a mouse and/or a keyboard that are configured to receive user input operations (i.e., having an input reception function). The user I/F 13 may include a touch panel having the display function of the display 13a and the input reception function.

The communication I/F 14 includes hardware configured to communicate with external devices such as the printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 may be configured to connect with the Internet via the communication I/F 14. The PC 1 may have a plurality of communication I/Fs 14 conforming to a plurality of communication standards.

As shown in FIG. 1, the memory 12 of the PC 1 stores various programs and various types of data. The various programs stored in the memory 12 include an operating system (hereinafter referred to as an “OS”) 21 including a generic print program 41, support programs 42, an image processing application 43, and a status monitor 44. The support programs 42 and the image processing application 43 may both be located within a sandbox. Alternatively, depending on the specifications of the OS 21, both may be located outside the sandbox. The support programs 42 may be an example of the “support program” according to aspects of the present disclosure, and may be an example of “first computer-readable instructions” according to aspects of the present disclosure. The image processing application 43 may be an example of a “specific application program” according to aspects of the present disclosure, and may be an example of “second computer-readable instructions” according to aspects of the present disclosure. A set of the support programs 42 and the image processing application 43 may be an example of a “program set” according to aspects of the present disclosure.

The OS 21 is a multitasking operating system configured to handle a plurality of tasks in parallel by managing the plurality of tasks and switching between/among the plurality of tasks. Examples of the OS 21 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC).

The OS 21 includes the generic print program 41. The generic print program 41 is an IPP (“IPP” is an abbreviation for “Internet Printing Protocol”) Class driver, and is an OS-standard program prepared by a vendor of the OS 21 and provided as part of the OS 21. Namely, the PC 1 incorporates the OS 21 having the generic print program 41. The generic print program 41 is not configured to use a printer driver specific to each printer.

The generic print program 41 is configured to cause a plurality of different models of printers, which are provided by a plurality of vendors, respectively, to perform printing based on user instructions. The generic print program 41 supports generic functions that enable many printers to perform printing. Unlike the printer driver specific to each printer, the generic print program 41 does not support functions specific to each printer or each printer driver, especially functions requiring complex processing.

The generic print program 41 has a function to, based on a user instruction, receive image data specified as a print target in a print instruction output from each type of application and generate intermediate data based on the received image data. For instance, the intermediate data is XPS data. The generic print program 41 further has a function to generate print data based on the intermediate data in a format usable for printing by various types of printers. For instance, the print data is PWGRaster data or PDF data. The generic print program 41 further has a function to send the generated print data to a printer specified as a print execution device via the communication function by the OS 21.

The support programs 42 include one program or a group of programs configured to perform processing based on an instruction from the OS 21, accompanying the processing by the generic print program 41. The support programs 42 are for supporting control of target hardware elements. The support programs 42 in the first illustrative embodiment are compatible with a model of the printer 2 connected with the PC 1. For instance, the support programs 42 are provided by the vendor of the printer 2. The generic print program 41 launches the support programs 42 compatible with the printer 2 in cases such as a case where the printer 2 has been selected as the print execution device, a case where the generic print program 41 has received an instruction for detailed print settings with the printer 2 selected, and a case where the generic print program 41 has received an instruction to cause the printer 2 to perform printing. The support programs 42 are called, for instance, PSA (“PSA” is an abbreviation for “Print Support Application”) or HSA (“HSA” is an abbreviation for “Hardware Support Application”).

For instance, the support programs 42 may include a combination of a plurality of programs each of which is configured to, when executed by the CPU 11, cause the PC 1 to receive execution instructions. In another instance, the support programs 42 may include one program configured to, when executed by the CPU 11, cause the PC 1 to receive instructions and perform respective different processes according to the received instructions. The support programs 42 may include a program prepared for each type of printer by the printer vendor(s). For instance, the support programs 42 may include a support program prepared for inkjet printers and a support program prepared for laser printers. The support programs 42 may include not only the support program prepared for each type of printer but also a support program prepared for each model of printer or a support program prepared for each series of models of printers.

For instance, when a new printer is connected with the PC 1, the OS 21 may cause the PC 1 to download an appropriate support program from a server of a printer vendor or another source depending on a type of the connected printer and to incorporate the downloaded support program into the PC 1. Then, the OS 21 may cause the PC 1 to store identification information of the incorporated support program in the memory 12 in association with printer information of the newly connected printer.

The image processing application 43 is a program for using the printer 2. For instance, the image processing application 43 is for causing the printer 2 to perform printing based on image data or perform image scanning to generate image data. The image processing application 43 may be configured to generate and edit image data. The image processing application 43 in the first illustrative embodiment is a program provided by the vendor of the printer 2. The image processing application 43 is configured to send to the printer 2 at least one of a print instruction to cause the printer 2 to perform printing or a scan instruction to cause the printer 2 to perform image scanning, based on a user instruction received via the user I/F 13.

The status monitor 44 is an application program configured to monitor a plurality of printers including the printer 2. More specifically, the status monitor 44 is configured to periodically communicate with printers to be monitored and acquire information indicating statuses of the printers.

As shown in FIG. 1, the PC 1 in the first illustrative embodiment is connected with the printer 2 via the communication I/F 14. The printer 2 has at least a printing function and a communication function. The printer 2 is configured to, in response to receiving a print job, e.g., from the PC 1, perform printing based on the received print job. The printer 2 may be configured to perform color printing or to perform only single-color printing.

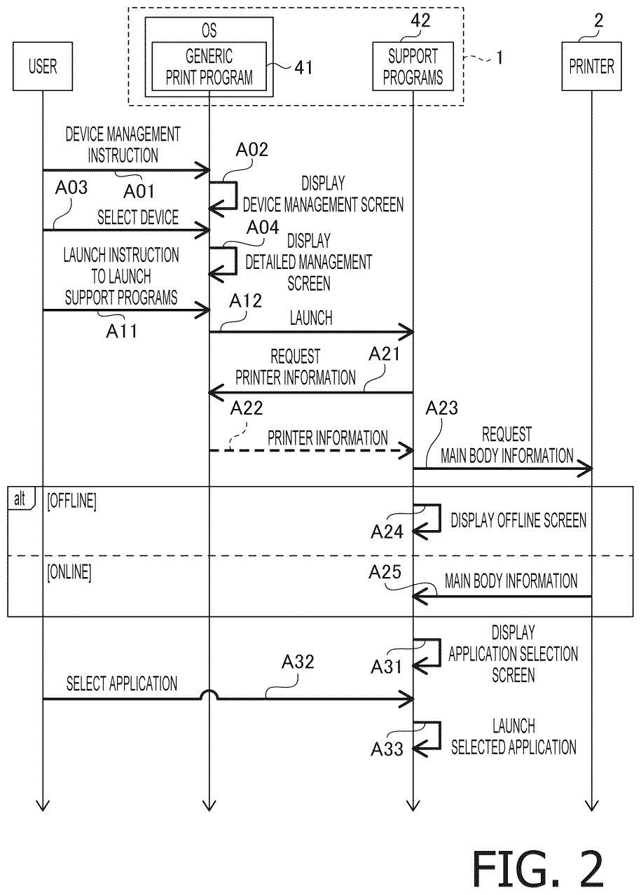

Next, an application management procedure for using the image processing application 43 on the PC 1 in the first illustrative embodiment will be described with reference to a sequence diagram in FIG. 2. The PC 1 in the first illustrative embodiment is connected with the printer 2. A printer queue corresponding to the printer 2 is created on the PC 1. In addition, the PC 1 incorporates the support programs 42 and the image processing application 43 that are compatible with the printer 2. The OS 21 registers the support programs 42 in association with the printer queue corresponding to the printer 2.

Each processing step other than user operations in the first illustrative embodiment basically indicates processing by the CPU 11 in accordance with instructions described in programs such as the support programs 42. In the present disclosure, an actual main entity that performs various types of processing in accordance with programs such as the support programs 42, the generic print program 41, and the OS 21 is the controller 10 or the CPU 11. However, the name of a corresponding one of the programs such as the support programs 42, the generic print program 41, and the OS 21 may be used to represent the main entity that performs each type of processing for the sake of explanatory convenience. The processing by the CPU 11 includes hardware control using an API (“API” is an abbreviation for “Application Programming Interface”) of the OS 21. In the present disclosure, operations and processes by the individual programs may be described without a detailed explanation of the OS 21. It is noted that “obtaining” and “acquiring” may be used as concepts that do not necessarily require a request.

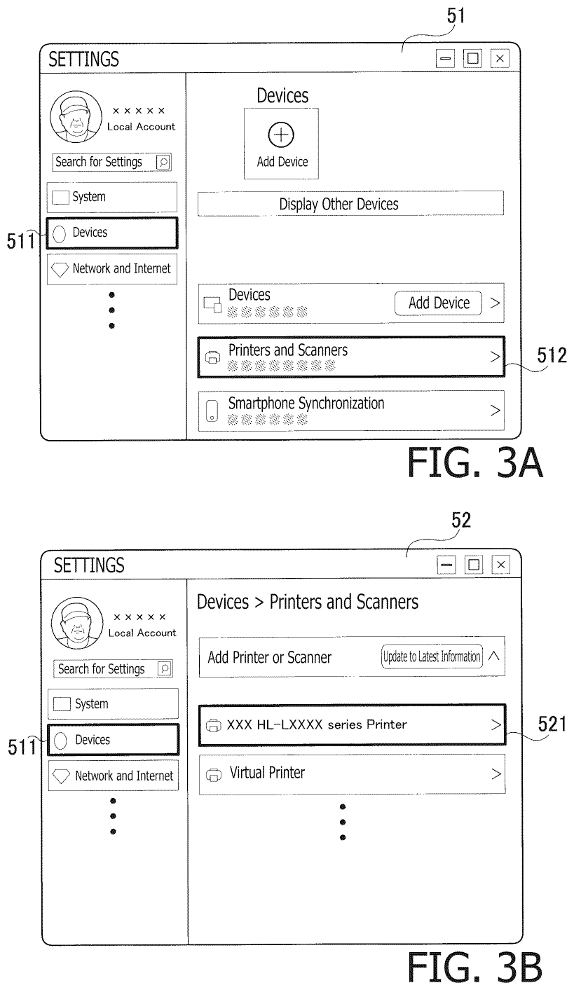

The OS 21 is configured to receive a setting instruction for each element included in the PC 1 from the user. The OS 21 is further configured to receive, on a screen for receiving setting instructions, device management instructions that include instructions to display information about various devices connected with the PC 1 and instructions to change settings for the various devices. For instance, when the OS 21 has received a setting instruction and a device management instruction (A01), the OS 21 is enabled to further receive device selection, e.g., as shown in FIGS. 3A and 3B. For instance, when the OS 21 has received an operation on a “Printers and Scanners” button 512 on a device setting screen 51 (see FIG. 3A) displayed in response to receiving an operation on a “Devices” button 511, the OS 21 causes the user I/F 13 to display a device management screen 52, e.g., as shown in FIG. 3B (A02).

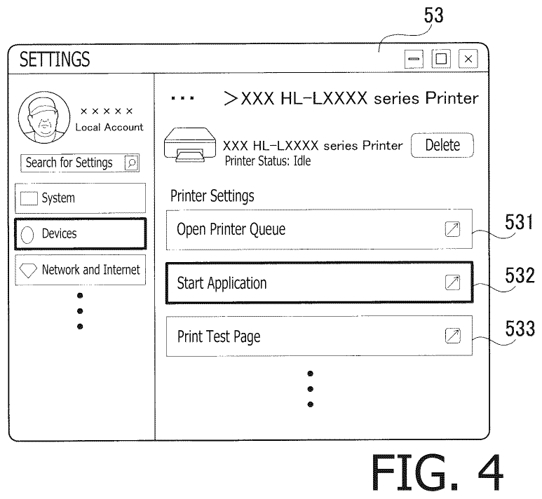

The device management screen 52 includes a list of various devices (e.g., printers and scanners) connected with the PC 1 and configured to perform image processing. The user may select a target device to be managed from the list displayed on the device management screen 52 (A03). For instance, in response to receiving an operation on a button 521 for specifying the printer 2 on the device management screen 52, the OS 21 causes the user I/F 13 to display a detailed management screen 53, e.g., as shown in FIG. 4 (A04).

For instance, the detailed management screen 53 is configured to display thereon an “Open Printer Queue” button 531, a “Start Application” button 532, and a “Print Test Page” button 533. The “Open Printer Queue” button 531 is configured to, when operated, receive an instruction to check a status of a printer queue corresponding to the selected printer. The “Start Application” button 532 is configured to, when operated, receive a launch instruction to launch an application corresponding to the selected printer. In response to receiving an operation on the “Start Application” button 532, the OS 21 launches the support programs 42 corresponding to the printer 2. The “Print Test Page” button 533 is configured to, when operated, receive an instruction to send a test image provided by the OS 21 to the selected printer. The OS 21 is enabled to receive user operations on the buttons 531, 532, and 533 on the detailed management screen 53.

When the OS 21 has received an operation on the “Start Application” button 532 via the detailed management screen 53 displayed with the printer 2 selected (A11), the OS 21 passes information on the selected printer 2, and the launch instruction to launch the program corresponding to the printer 2 to the generic print program 41. The generic print program 41 is configured to launch the program associated with the printer information of the printer 2 in response to receiving the launch instruction from the OS 21. In the first illustrative embodiment, the identification information of the support programs 42 is stored in association with the printer information of the printer 2. Therefore, in this case, the generic print program 41 launches the support programs 42 (A12).

When the support programs 42 have been launched from the generic print program 41 in response to a user operation on the “Start Application” button 532, the support programs 42 first send a request for printer information of the printer 2 to the OS 21 (A21). The support programs 42 then acquire the printer information from the OS 21 (A22). The printer information is information for identifying the printer 2. The printer information includes, for instance, a model name and an IP address of the printer 2.

By acquiring the model name and the IP address of the printer 2, the support programs 42 are allowed to identify the printer 2 and communicate with the printer 2. The support programs 42 then send a request for main body information to the printer 2 (A23).

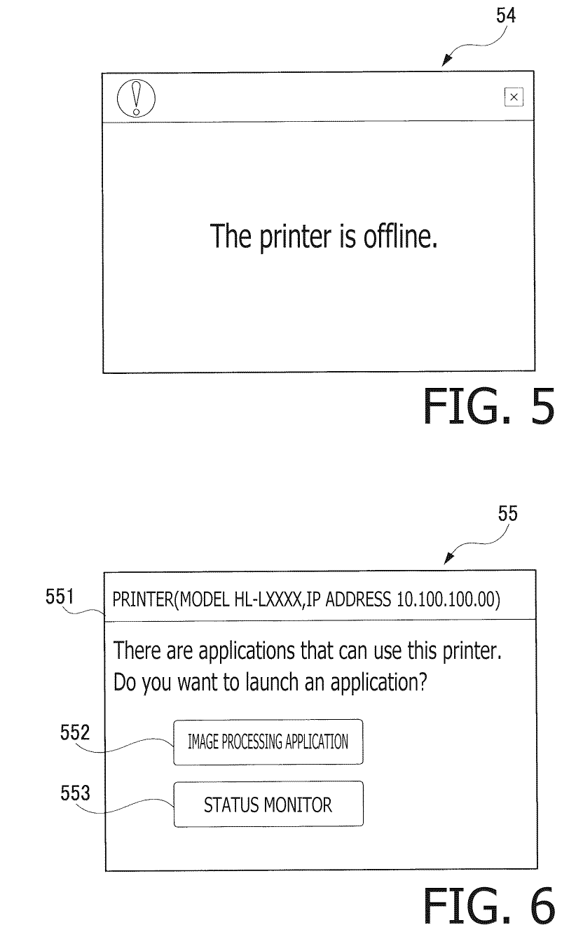

At this time, if the printer 2 is offline (alt: [Offline]), the support programs 42 are unable to acquire the main body information as requested in A23. In this case, the support programs 42 cause the user I/F 13 to display an offline notification screen 54 to provide a notification that the printer 2 is offline, for instance, as shown in FIG. 5 (A24). The support programs 42 may retry to send the same request as in A23.

If the printer 2 is online (alt: [Online]), the support programs 42 acquire the main body information from the printer 2 (A25). The main body information includes, for instance, print setting information indicating parameters included in print settings used for printing by the printer 2, information indicating parameters that are settable for each item of the print settings, information indicating remaining amounts and model numbers of consumables, information on selectable trays, and information on a sheet size of sheets set in each tray. The parameters included in the print settings used for printing by the printer 2 include, for instance, a default sheet size, information indicating whether duplex printing is acceptable, color settings for copying, layout information for copying, information indicating whether background color removal copying is to be performed, and information on a feed tray and a discharge tray. Thus, the main body information includes the print setting information, and further includes consumable information regarding the consumables for the printer 2.

The support programs 42 are configured to directly acquire the main body information from the printer 2, for instance, using an MIB (“MIB” is an abbreviation for “Management Information Base”). The support programs 42 may be configured to acquire the main body information by sending a request for the main body information to the generic print program 41. The generic print program 41 is configured to communicate with the printer 2 through the OS 21, for instance, via communication according to the IPP. The support programs 42 are enabled to acquire information on the print settings from the printer 2, thereby acquiring information on the print settings currently set for the printer 2.

The support programs 42 then cause the user I/F 13 to display an application selection screen configured to receive a user selection of which application is to be launched among applications that use the printer 2 (A31). More specifically, for instance, as shown in FIG. 6, the support programs 42 cause the user I/F 13 to display the application selection screen 55 configured to receive a user selection of an application to be launched from among various applications that are incorporated in the PC1 and enabled to use the printer 2. The support programs 42 then receive a user operation on the application selection screen 55 (A32). The application selection screen 55 includes printer identification information 551 indicating the currently selected printer 2, a button 552 to receive an instruction to launch the image processing application 43, and a button 553 to receive an instruction to launch the status monitor 44. The printer identification information 551 displayed on the application selection screen 55 includes information indicating the printer 2 based on the printer information acquired from the OS 21 in A22.

Thus, in the first illustrative embodiment, the printer identification information 551 for identifying the printer 2 is displayed on the application selection screen 55. Thereby, the user is allowed to grasp information on the printer 2 that is currently selected. In addition to the image processing application 43 and the status monitor 44, the PC 1 may further incorporate other applications that are enabled to use the printer 2, such as a fax transmission application, a disk label application, a New Year's card application, and a label application. In such a case, the application selection screen 55 may include a button configured to receive an instruction to launch each application incorporated in the PC 1.

In response to receiving a user operation on the application selection screen 55, the support programs 42 launch an application selected by the user (A33). For instance, if the user operates the button 552, the support programs 42 determine to launch the image processing application 43.

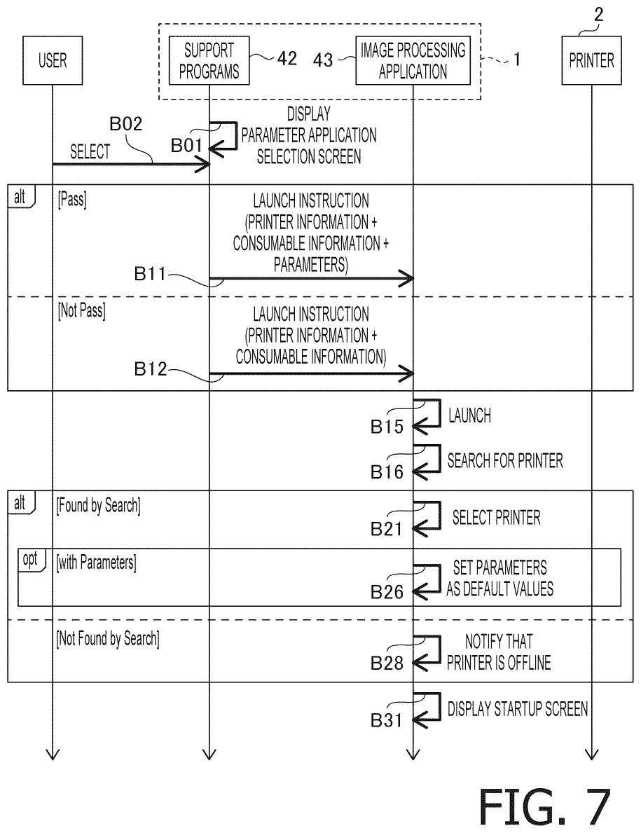

Next, an application startup procedure to launch a specified application based on the user selection in A32 will be described with reference to a sequence diagram shown in FIG. 7. In the following description, it is assumed that the user has operated the button 552 in FIG. 6 to select the image processing application 43 as an application to be used.

In response to the image processing application 43 being selected, the support programs 42 cause the user I/F 13 to display a parameter application selection screen configured to receive a user selection of whether to pass the parameters of the print settings set for the printer 2 to the image processing application 43 (B01). The support programs 42 then receive, via the parameter application selection screen, a user selection of whether to pass the parameters of the print settings set for the printer 2 to the image processing application 43 (B02).

The parameters of the print settings set for the printer 2 are information used for printing by the printer 2, and are information included in the main body information acquired from the printer 2 in A25 of FIG. 2. If the printer 2 is offline, the support programs 42 are unable to acquire the main body information from the printer 2. Therefore, in this case, the support programs 42 may receive an instruction not to pass the parameters of the print settings set for the printer 2 without executing B01 to B02.

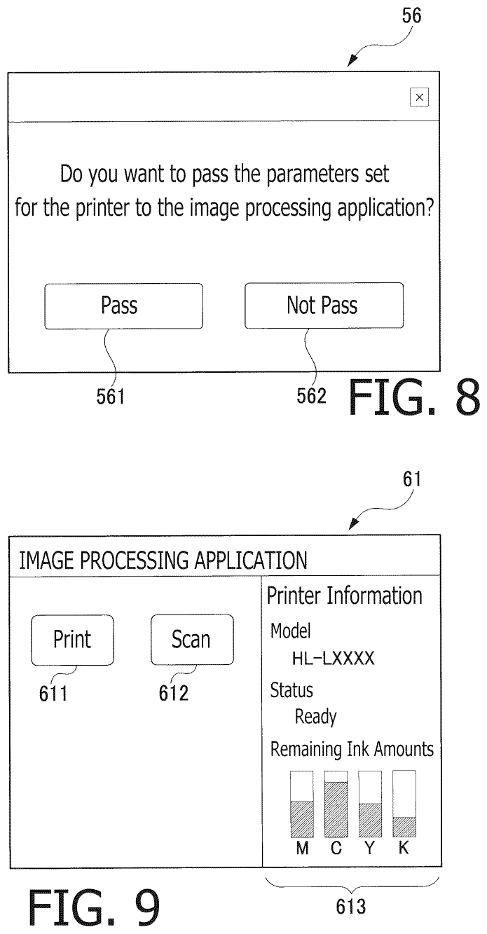

The image processing application 43 is configured to receive a print instruction and a scan instruction and to use information on the print settings set for the printer 2. In B01, the support programs 42 cause the user I/F 13 to display a parameter application selection screen 56 (see FIG. 8). As shown in FIG. 8, the parameter application selection screen 56 includes, for instance, a message to ask the user whether to pass the parameters of the print settings set for the printer 2 to the image processing application 43, a button 561 to receive an instruction to pass the parameters of the print settings set for the printer 2, and a button 562 to receive an instruction not to pass the parameters of the print settings set for the printer 2.

In response to determining that the instruction to pass the parameters of the print settings set for the printer 2 has been received based on an operation on the button 561 (alt: [Pass]), the support programs 42 associate the printer information, the consumable information, and the parameters with each other, and launch the image processing application 43 (B11). Meanwhile, in response to determining that the instruction not to pass the parameters of the print settings set for the printer 2 has been received based on an operation on the button 562 (alt: [Not Pass]), the support programs 42 associate the printer information with the consumable information, and launch the image processing application 43 (B12).

The printer information is information acquired by support programs 42 from the OS 21 in A22 of FIG. 2, and includes the model name and the IP address of the printer 2. The consumable information is information included in the main body information acquired by the support programs 42 from the printer 2 in A25 of FIG. 2.

Thus, in the first illustrative embodiment, the user is allowed to select whether to pass the information on the print settings set for the printer 2 to the image processing application 43. Thereby, it is possible to set default values of the print settings according to the user's convenience. The selection of whether to cause the support programs 42 to pass the information (i.e., the parameters) of the print settings set for the printer 2 to the image processing application 43 may be received collectively for all items related to the print settings, or may be received for each individual item.

When the image processing application 43 has been launched by an instruction in B11 or B12 (B15), the image processing application 43 searches for the printer 2 using the printer information received from the support programs 42 (B16). For instance, the image processing application 43 sends a search signal and waits for a response signal to be received. The image processing application 43 then determines whether a response has been received from the printer 2.

In response to receiving a response from a device matching the printer information, the image processing application 43 determines that the printer 2 has been found by the search (alt: [Found by Search]) and selects the printer 2 as a printer to be used by the image processing application 43 (B21).

If the printer information includes only a model name, the image processing application 43 is unable to identify the printer 2 when there are a plurality of printers of the same model. In addition, if the printer information includes only an IP address, the image processing application 43 may select a printer different from the selected printer 2 since the same IP address may be set for different model printers. The support programs 42 passes the printer information including the model name and the IP address of the selected printer 2 to the image processing application 43. Therefore, the image processing application 43 is allowed to properly search for the printer 2 selected by the user on the device management screen 52 (see FIG. 3B).

Furthermore, when the image processing application 43 has been launched by the launch instruction associated with the parameters of the print settings (opt: [with Parameters]), the image processing application 43 sets the parameters of the print settings provided with the launch instruction by the support programs 42 as default values of the print settings in the image processing application 43 (B26). By setting the parameters of the print settings set for the printer 2 to the default values of the print settings in the image processing application 43, the image processing application 43 is enabled to use the printer 2 with appropriate print settings. Thus, the user is enabled to save time and effort required for an operation to select parameters.

On the other hand, when the printer 2 has not been found by the search in B16 (alt: [Not Found by Search]), the image processing application 43 provides a notification that the printer 2 is offline (B28). The image processing application 43 causes the user I/F 13 to display the offline notification screen 54, for instance, as shown in FIG. 5.

When the support programs 42 provide the notification that the printer 2 is offline in A24 of FIG. 2, the user is enabled to realize that the printer 2 is offline before activating the image processing application 43. In addition, when the image processing application 43 provides the notification that the printer 2 is offline in B28 of FIG. 7, it is possible to notify the user that the image processing application 43 is unable to use the printer 2. The CPU 11 may execute only one of A24 in FIGS. 2 and B28 in FIG. 7.

The image processing application 43 then causes the user I/F 13 to display a startup screen (B31). When the image processing application 43 has been launched, the image processing application 43 causes the user I/F 13 to display a startup screen 61, for instance, as shown in FIG. 9. The startup screen 61 includes a button 611 configured to receive a print instruction to cause the printer 2 to perform printing as a process to be performed via the image processing application 43. The startup screen 61 further includes a button 612 configured to receive a scan instruction to cause the printer 2 to perform image scanning as a process to be performed via the image processing application 43. In addition, when the image processing application 43 has received the printer information and the consumable information from the support programs 42, the image processing application 43 causes the user I/F 13 to display the startup screen 61 including the model name and the consumable information of the printer 2 as information 613 of the printer 2. Thus, in the first illustrative embodiment, the support programs 42 acquire the consumable information from the printer 2 and pass the acquired consumable information to the image processing application 43. Thereby, the image processing application 43 is enabled to cause the user I/F 13 to display the consumable information on the startup screen 61. Accordingly, for instance, when the remaining amount of a consumable item is small, the image processing application 43 is enabled to notify the user of the information.

When the printer 2 was offline at the time of A23 in FIG. 2, and therefore the support programs 42 were unable to acquire the main body information, the support programs 42 may provide a launch instruction to launch the image processing application 43 without associating the launch instruction with the consumable information. In this case, the image processing application 43 may acquire the main body information from the printer 2, when the image processing application 43 has been launched and then found the printer 2 by the search. In addition, the image processing application 43 may be normally launched to be ready to receive a selection of a printer according to a user operation, when the image processing application 43 has not found the device that matches the printer information provided when the image processing application 43 was launched.

In response to receiving an operation on the button 553 on the application selection screen 55, the support programs 42 launch the status monitor 44. In this case, the support programs 42 provide a launch instruction to launch the status monitor 44 in association with the printer information. The status monitor 44 causes the user I/F 13 to display a status screen to show status information of the printer 2 corresponding to the printer information provided when the status monitor 44 was launched. The status screen displays thereon the status information that includes, for instance, information on the remaining amounts of consumables for the printer 2 and error information.

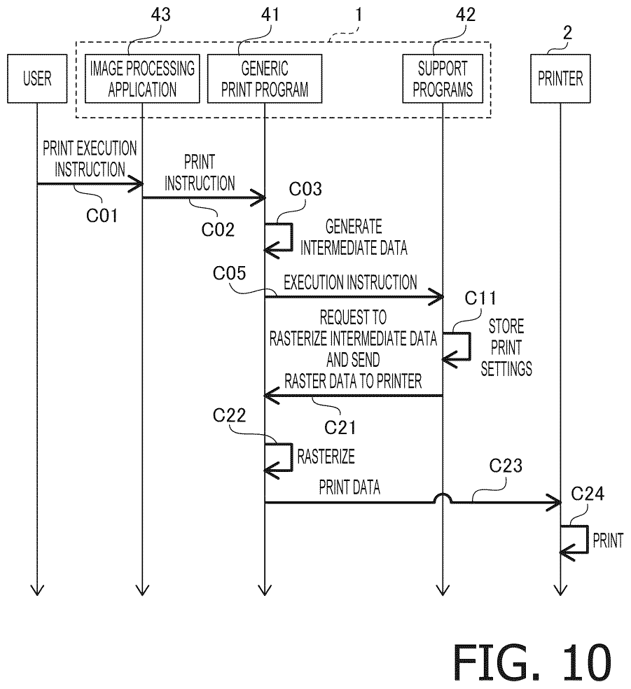

Next, a print execution procedure will be described with reference to a sequence diagram in FIG. 10. In the following description, it is assumed that the printer 2 is online and that the printer 2 is selected by the launched image processing application 43. For instance, the user may start the procedure for causing the printer 2 to perform printing using the image processing application 43 by operating the button 611 on the startup screen 61 shown in FIG. 9.

After the user has determined a target image to be printed and the print settings for the printer 2, the user inputs a print execution instruction into the image processing application 43 (C01). The generic print program 41 is incorporated in the OS 21 of the PC 1. Therefore, the image processing application 43 determines that the print execution instruction to cause the printer 2 to print the currently selected image has been received for the generic print program 41.

When the image processing application 43 has received the parameters of the print settings from the support programs 42, the image processing application 43 may receive the user selection of the received parameters as information on selectable print settings. For instance, if information on the sheet size of sheets set in a tray of the printer 2 is included in the parameters of the print settings, the image processing application 43 may receive a user selection of the information on the sheet size as a selectable sheet size. Thus, it is possible to reduce the user's effort for selecting the sheet size and, for instance, to reduce the possibility of selecting a non-selectable sheet size.

The image processing application 43 provides a print instruction as information on the received print execution instruction to the generic print program 41 (C02). The generic print program 41 acquires, as the information on the print execution instruction, image data representing the target image to be printed, and information indicating the print settings from the image processing application 43.

The generic print program 41 converts a format of the image data of the target image to be printed to a format of intermediate data based on the information acquired from the image processing application 43, thereby generating intermediate data (C03). Image data contained in the image processing application 43 may be of various types. The generic print program 41 converts the image data of the target image to be printed into the intermediate data suitable for generating print data. If the image data of the target image to be printed is data suitable for generating print data, the generic print program 41 may use the image data of the target image to be printed as is as intermediate data, without generating intermediate data.

Before generating the intermediate data, the generic print program 41 may launch the support programs 42 compatible with the printer 2 which is the specified device, thereby providing a notification that processing of the print job has been started. When the support programs 42 have been launched by the generic print program 41, the support programs 42 may pass information indicating various instructions used in generating the intermediate data to the generic print program 41 as necessary.

After generating the intermediate data, the generic print program 41 launches the support programs 42 (C05). The support programs 42 are enabled to send a request to the generic print program 41, thereby acquiring the intermediate data generated by the generic print program 41 and the print settings. The support program 42 are further enabled to edit information on the intermediate data and the print settings received from the generic print program 41 as necessary.

The support programs 42 store the information on the print settings of the received print job in the memory 12 (C11). When the support programs 42 have received the print job based on the print instruction output from the image processing application 43, the support programs 42 overwrite the stored information on the print settings (e.g., the latest information on the print settings as stored) with the information on the print settings of the received print job. When the information on the print settings of the print job is stored in the memory 12, the support programs 42 may use the stored information on the print settings instead of the print settings of the main body information acquired or to be acquired in A25 in FIG. 2. For instance, when the printer 2 is offline in A23 of FIG. 2, the support program 42 may read and acquire the print settings stored in the memory 12. By acquiring the information on the print settings used for printing, the user is enabled to save time and effort when attempting to perform printing with the same settings.

The support programs 42 may store not only the latest information on the print settings, but also a plurality of pieces of information on the print settings. When the support programs 42 store a plurality of pieces of information on the print settings, the support programs 42 may acquire, for instance, the most frequently used parameters as information on the print settings from among the plurality of pieces of information on the print settings. In addition, when the support programs 42 store a plurality of pieces of information on the print settings, the support programs 42 may limit the number of pieces of information on the print settings to be stored. For instance, the support programs 42 may store only the print settings of print jobs received within a particular period of time.

The support programs 42 pass the intermediate data to the generic print program 41 and make a request to the generic print program 41 to rasterize the intermediate data and send raster data to the printer 2 (C21). In response to the request from the support programs 42, the generic print program 41 rasterizes the intermediate data to generate raster data which is bitmap data (C22), and sends a print job including the generated raster data to the printer 2 (C23).

The support programs 42 may perform the rasterization instead of the generic print program 41. In this case, the support programs 42 perform the rasterization based on the intermediate data acquired when the support programs 42 received an execution instruction from the generic print program 41 (see C05 in FIG. 10), thereby generating the raster data. When the rasterization is performed by the support programs 42, it is highly likely that the raster data suitable for printing by the printer 2 is generated with a higher degree of freedom than when the rasterization is performed by the generic print program 41. Meanwhile, when the rasterization is performed by the generic print program 41, it is possible to achieve less processing by the support programs 42 and a smaller program size of the support programs 42.

In addition, the support programs 42 may acquire the raster data generated by the generic print program 41 or the support programs 42 and process the acquired raster data as necessary. For instance, the support programs 42 may encode the raster data into PDL data suitable for the printer 2 and generate the print data. The PDL data generated by the support programs 42 may be in a format that is also usable for printing by printers other than the model of the printer 2.

The printer 2 performs printing based on the received print data (C24). Thereby, a printed matter based on the print instruction output from the image processing application 43 is generated.

In the first illustrative embodiment, the generic print program 41 sends the print job to the printer 2. However, the support program 42 may send print data, and a print command to instruct the printer 2 to perform printing. For instance, if settings related to image processing executable by the printer 2 are included as print settings, the support programs 42 may generate a print command that includes information about the image processing. In this case, after the transmission of the print data is completed, the support programs 42 may provide a notification that the transmission of the print data is completed to the generic print program 41.

As described in detail above, the OS 21 of the PC 1 is configured to receive a launch instruction to launch the support programs compatible with the selected printer. The support programs 42 in the first illustrative embodiment are compatible with the printer 2. The support programs 42 are configured to, when launched in response to the OS 21 receiving the launch instruction with the printer 2 selected, cause the CPU 11 to acquire the printer information for identifying the printer 2. The support programs 42 are further configured to, in response to receiving an instruction to launch the image processing application 43, cause the CPU 11 to launch the image processing application 43 and cause the image processing application 43 to pass the printer information of the printer 2. This enables the image processing application 43 to select the printer 2 based on the printer information. Thus, the user is enabled to save time and effort required for an operation to select the printer 2 after the image processing application 43 is launched, since such a user operation is unnecessary.

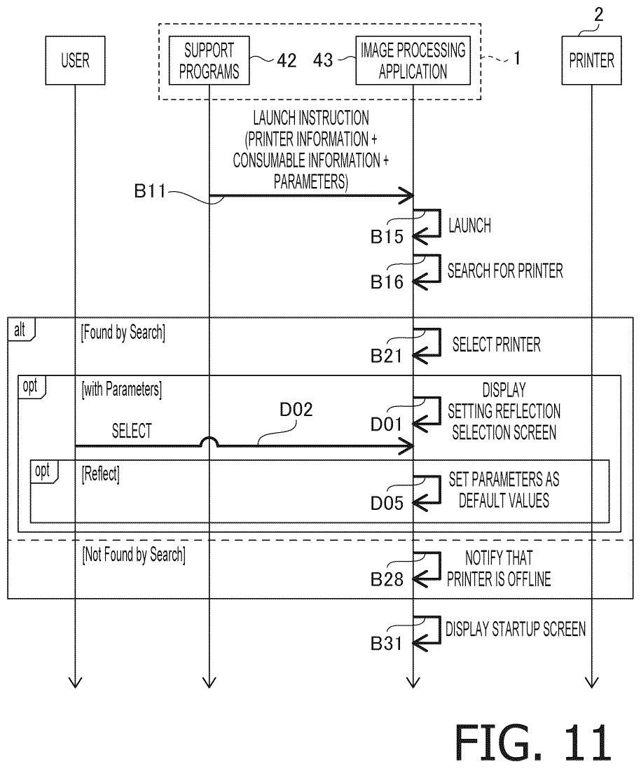

Subsequently, a support program and a program set in a second illustrative embodiment according to aspects of the present disclosure will be described in detail with reference to the relevant accompanying drawings. The second illustrative embodiment differs from the aforementioned first illustrative embodiment only in the application startup procedure (see FIG. 7). The second illustrative embodiment is substantially the same as the first illustrative embodiment with respect to the application management procedure (see FIG. 2) and the print execution procedure (see FIG. 10). In the second illustrative embodiment, substantially the same configurations and procedures as in the first illustrative embodiment will be provided with the same reference characters, and detailed explanations thereof may be omitted. An application startup procedure of the second illustrative embodiment is described with reference to a sequence diagram shown in FIG. 11.

The support programs 42 in the second illustrative embodiment do not receive a user selection, as shown in B01 to B02 of FIG. 7, of whether to pass the parameters of the print settings set for the printer 2 to the image processing application 43. When the image processing application 43 is selected in response to an operation on the button 552 in FIG. 6, and the main body information has been acquired from the printer 2 in A25 of FIG. 2, the support programs 42 in the second illustrative embodiment provide a launch instruction to launch the image processing application 43 in association with information contained in the main body information as parameters, without making an inquiry to the user (B11).

When the image processing application 43 has been launched (B15), the image processing application 43 searches for the printer 2 using the printer information received from the support programs 42 (B16). In response to determining that the printer 2 has been found by the search (alt: [Found by Search]), the image processing application 43 selects the printer 2 as a printer to be used by the image processing application 43 (B21).

Furthermore, when the image processing application 43 has been launched by the launch instruction associated with the parameters of the print settings (opt: [with Parameters]), the image processing application 43 causes the user I/F 13 to display a setting reflection selection screen (D01), and receives a user selection via the setting reflection selection screen (D02). The setting reflection selection screen is configured to receive a selection of whether to set the parameters as default values of the print settings in the image processing application 43. A process of D01 to D02 is a process to receive a selection of whether to set the parameters of the print settings provided by the support programs 42 as the default values of the print settings in the image processing application 43.

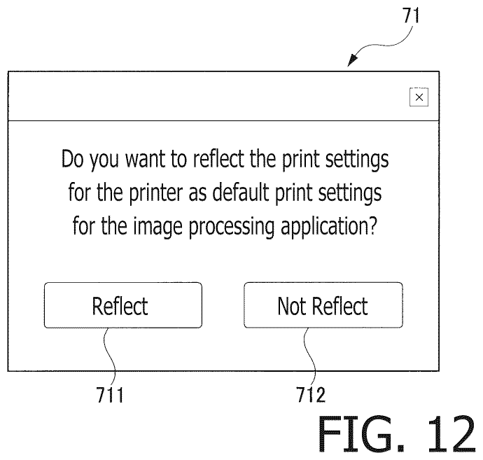

Specifically, in D01, the image processing application 43 causes the user I/F 13 to display a setting reflection selection screen 71, for instance, as shown in FIG. 12. The setting reflection selection screen 71 includes a message for asking the user whether to reflect the print settings for the printer 2 as the default print settings for the image processing application 43, a button 711 for receiving an instruction to reflect the print settings for the printer 2 as the default print settings for the image processing application 43, and a button 712 for receiving an instruction not to reflect the print settings for the printer 2 as the default print settings for the image processing application 43.

In response to receiving an operation on the button 711 to receive the instruction to reflect the print settings for the printer 2 as the default print settings for the image processing application 43 (opt: [Reflect]), the image processing application 43 sets the parameters of the print settings provided with the launch instruction by the support programs 42 to the default values of the print settings in the image processing application 43 (D05). By setting the print settings set for the printer 2 to the default values of the print settings in the image processing application 43, the image processing app 43 is enabled to use the printer 2 with the appropriate settings. Thus, the user is enabled to save time and effort required for an operation of selecting parameters.

On the other hand, when the printer 2 has not been found by the search in B16 (alt: [Not Found by Search]), the image processing application 43 provides a notification that the printer 2 is offline (B28).

The image processing application 43 then causes the user I/F 13 to display the startup screen 61 as shown in FIG. 9 (B31). This enables the user to cause the printer 2 to perform printing or image scanning using the image processing application 43.

As described in detail above, the support programs 42 and the set of the support programs 42 and the image processing application 43 in the second illustrative embodiment do not require any user operation to select the printer 2 after the image processing application 43 is launched, in substantially the same manner as in the aforementioned first illustrative embodiment. Thus, the user is enabled to save time and effort required for an operation to select parameters.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

Examples of the printer connected with the PC 1 are not limited to a device with a single function of printing, but may include any other device as long as it has the printing function, such as a multi-function peripheral, a copier, and a fax machine. The number of printers connected with the PC 1 may be two or more.

All the illustrated examples of the screens displayed on the user I/F 13 are merely examples, and are not limited to those shown in the respective drawings. The features (e.g., the wording, the shapes of the objects, and the background) displayed in each screen shown in the corresponding drawing may be of any kind. In addition, the processes (e.g., A24 in FIGS. 2 and B28 in FIG. 7) to provide the notification that the printer 2 is offline may be omitted.

In the present disclosure, when the support programs 42 have been launched from the OS 21 (see A12 in FIG. 2), the support programs 42 cause the CPU 11 to acquire the model name and the IP address of the printer 2 as the printer information. However, practicable examples of the information to be acquired are not limited to the specific examples described in the present disclosure. The printer information may be any information as long as it includes information for identifying the printer 2. For instance, the printer information may include at least one of a printer name, a serial number, or an installation location of the printer 2, or may include a combination of at least two of them. The printer information may include a part of the main body information.

In the present disclosure, the launched image processing application 43 searches for the printer 2. However, when the image processing application 43 has received an IP address as the printer information, the image processing application 43 may attempt to communicate with the printer 2 using the received IP address. The image processing application 43 may be configured to communicate directly with the printer 2 when the IP address is included in the printer information, and to search for the printer 2 when the IP address is not included in the printer information.

The information that the support programs 42 acquire from the printer 2 and pass to the image processing application 43 may not include the consumable information. The image processing application 43 may be configured to not display the consumable information on the startup screen even when it has received the consumable information.

In the present disclosure, the support programs 42 store the information on the print settings of the print job in the memory 12. However, the support programs 42 may not store the information on the print settings of the print job in the memory 12. Namely, C11 in FIG. 10 may be omitted.

In the present disclosure, the image processing application 43 has been described as an example of the application to be launched from the support programs 42. However, practicable examples of the application to be launched from the support programs 42 may include any application that is enabled to use the printer 2. Further, the present disclosure has described an example in which the support programs 42 cause the CPU 11 to acquire the parameters of the print settings as the main body information from the printer 2. However, when the printer 2 has a scanning function, the support program 42 may cause the CPU 11 to acquire parameters of scan settings as the main body information from the printer 2. Further, the support programs 42 may be configured to, depending on a specified application to be launched, discard or select parameters to be passed to the specified application.

In the aforementioned first illustrative embodiment, prior to activating the image processing application 43, the support programs 42 cause the user I/F 13 to display the parameter application selection screen 56 (see FIG. 8) and receive a user selection (B01-B02 in FIG. 7). In the aforementioned second illustrative embodiment, the launched image processing application 43 causes the user I/F 13 to display the setting reflection selection screen 71 (see FIG. 12), and receives a user selection (D01-D02 in FIG. 11). However, practicable examples are not limited to the above specific examples. For instance, both of the above procedures in the first and second illustrative embodiments may be performed, or neither may be performed. In this regard, however, if the selection is received by the support programs 42 and then further received by the image processing application 43, it will require more time and effort from the user. In addition, since there may be users who do not wish to apply the parameters, it is preferable to receive the selection rather than to apply the parameters without receiving the selection.

In the aforementioned illustrative embodiments, only the printing operation has been described in detail as an operation performed by the CPU 11 executing the support programs 42. However, the support programs 42 may further have other roles. Examples of the program to perform the processing in the aforementioned illustrative embodiments are not limited to the support programs 42, but may include any program configured to receive instructions from the OS 21 or the generic print program 41 when printing is performed using the generic print program 41. For instance, a print workflow application (Print workflow) whose specifications have been published by Microsoft Corp. may be included in the examples of the program to perform the processing in the aforementioned illustrative embodiments.

Practicable examples of the execution timing for executing the support programs 42 are not limited to the example(s) in the aforementioned illustrative embodiments. For instance, the support programs 42 may be executed in response to a direct execution instruction from the OS 21. In another instance, the support programs 42 may be resident programs. In this case, the support programs 42 may perform the aforementioned operations in response to receiving execution commands.

In any flowchart disclosed in the aforementioned illustrative embodiments, a plurality of processes in a plurality of any steps may be arbitrarily changed in the execution order thereof or may be executed in parallel as long as there is no inconsistency in the processing results.

The processing disclosed in the aforementioned illustrative embodiments may be performed by one or more CPUs, one or more hardware elements such as ASICs, or a combination of at least two selected therefrom. The processing disclosed in the aforementioned illustrative embodiments may be implemented in various aspects such as a non-transitory computer-readable storage medium storing computer-readable instructions (e.g., programs) for performing the processing, or a method for performing the processing.

The following shows examples of associations between elements illustrated in the aforementioned illustrative embodiment(s) and modification(s), and elements claimed according to aspects of the present disclosure. For instance, the PC 1 may be an example of an “information processing device” according to aspects of the present disclosure. The CPU 11 may be an example of a “computer” according to aspects of the present disclosure. The controller 10 may be an example of a “controller” according to aspects of the present disclosure. The memory 12 may be an example of a “non-transitory computer-readable storage medium” according to aspects of the present disclosure. The user I/F 14 may be an example of a “user interface” according to aspects of the present disclosure. The printer 2 may be an example of a “particular printing device” according to aspects of the present disclosure. The OS 21 may be an example of an “operating system” according to aspects of the present disclosure. The generic print program 41 may be an example of a “generic print program” according to aspects of the present disclosure. The support programs 42 may be an example of a “support program” according to aspects of the present disclosure, and may be an example of a “first program” according to aspects of the present disclosure. The image processing application 43 may be an example of a “specific application program” according to aspects of the present disclosure, and may be an example of a “second program” according to aspects of the present disclosure. A set of the support programs 42 and the image processing application 43 may be an example of a “program set” according to aspects of the present disclosure.

What is claimed is:

1. A non-transitory computer-readable storage medium storing computer-readable instructions that are executable by a computer of an information processing device, the computer-readable instructions comprising a support program configured to support a generic print program standardly implemented with an operating system of the information processing device, the support program being further configured to, when executed by the computer, cause the information processing device to:
in a case where a first launch instruction to launch the support program compatible with a particular printing device has been received by the operating system, acquire printer identification information for identifying the particular printing device; and
in a case where a second launch instruction to launch a specific application program has been received via a user interface of the information processing device, provide the specific application program with a launch instruction to launch the specific application program and the acquired printer identification information, the specific application program being configured to receive selection of a printing device and receive a print instruction to cause the selected printing device to perform printing, the printer identification information being used for the specific application program to select the particular printing device.

2. The non-transitory computer-readable storage medium according to claim 1,
wherein the support program is further configured to, when executed by the computer, cause the information processing device to:
in a case where a print instruction to cause the particular printing device to print a target image has been output from an application program incorporated in the information processing device to the generic print program, acquire image data representing the target image from the generic print program, and perform processing to send a print job based on the image data to the particular printing device.

3. The non-transitory computer-readable storage medium according to claim 1,
wherein the generic print program is an IPP (Internet Printing Protocol) Class driver.

4. The non-transitory computer-readable storage medium according to claim 1,
wherein the support program is further configured to, when executed by the computer, cause the information processing device to acquire, as the printer identification information, a model name of the particular printing device, and an IP address set for the particular printing device.

5. The non-transitory computer-readable storage medium according to claim 1,
wherein the support program is further configured to, when executed by the computer, cause the information processing device to:
in the case where the first launch instruction has been received by the operating system with the particular printing device selected, acquire print setting information that indicates parameters included in print settings used for printing by the particular printing device; and
in said providing the launch instruction to launch the specific application program, pass the acquired printer identification information to the specific application program as information used for the specific application program to select the particular printing device, and pass the acquired print setting information to the specific application program as information used as default values of the print settings in the specific application program.

6. The non-transitory computer-readable storage medium according to claim 5,
wherein the support program is further configured to, when executed by the computer, cause the information processing device to acquire, as the print setting information, at least a sheet size included in the print settings.

7. The non-transitory computer-readable storage medium according to claim 5,
wherein the support program is further configured to, when executed by the computer, cause the information processing device to acquire the print setting information stored in the particular printing device from the particular printing device.

8. The non-transitory computer-readable storage medium according to claim 5,
wherein the support program is further configured to, when executed by the computer, cause the information processing device to:
in the case where the print instruction to cause the particular printing device to print the target image has been output from the specific application program to the generic print program, store print settings of the print job in a memory of the information processing device; and
acquire the print setting information based on the print settings stored in the memory.

9. The non-transitory computer-readable storage medium according to claim 5,
wherein the support program is further configured to, when executed by the computer, cause the information processing device to:
in the case where the second launch instruction to launch the specific application program has been received, receive a designation of whether to pass the acquired print setting information to the specific application program, via the user interface of the information processing device, prior to said providing the launch instruction to launch the specific application program; and
in said providing the launch instruction to launch the specific application program, perform corresponding processing depending on the received designation of whether to pass the print setting information to the specific application program, thereby passing the print setting information to the specific application program in response to receiving a designation for passing the print setting information to the specific application program, whereas not passing the print setting information to the specific application program in response to receiving a designation for not passing the print setting information to the specific application program.

10. The non-transitory computer-readable storage medium according to claim 1,
wherein the support program is further configured to, when executed by the computer, cause the information processing device to:
in the case where the first launch instruction to launch the support program compatible with the particular printing device has been received by the operating system with the particular printing device selected, acquire consumable information regarding consumables for the particular printing device from the particular printing device; and
in said providing the launch instruction to launch the specific application program, pass the acquired printer identification information to the specific application program as information used for the specific application program to select the particular printing device, and pass the acquired consumable information to the specific application program as information used for the specific application program to provide a notification about the consumables.

11. The non-transitory computer-readable storage medium according to claim 1,
wherein the support program is further configured to, when executed by the computer, cause the information processing device to:
in said providing the launch instruction to launch the specific application program, pass the acquired printer identification information to the specific application program as information used for the specific application program to select the particular printing device, and provide a notification that the particular printing device is offline if the particular printing device is offline.

12. The non-transitory computer-readable storage medium according to claim 1,
wherein the support program is further configured to, when executed by the computer, cause the information processing device to:
in said receiving the second launch instruction to launch the specific application program, display a screen that includes an operable object associated with the second launch instruction, and the acquired printer identification information, and receive the second launch instruction in response to an operation on the operable object.

13. A non-transitory computer-readable storage medium storing computer-readable instructions that are executable by a computer of an information processing device, the computer-readable instructions comprising a program set that includes a first program and a second program,
wherein the first program is a support program configured to support a generic print program standardly implemented with an operating system of the information processing device,
wherein the second program is a specific application program configured to receive selection of a printing device and receive a print instruction to cause the selected printing device to perform printing,
wherein the first program is further configured to, when executed by the computer, cause the information processing device to:
in a case where a first launch instruction to launch the first program compatible with a particular printing device has been received by the operating system, acquire printer identification information for identifying the particular printing device; and
in a case where a second launch instruction to launch the second program has been received via a user interface of the information processing device, provide the second program with a launch instruction to launch the second program and the acquired printer identification information, the printer identification information being used for the second program to select the particular printing device, and
wherein the second program is further configured to, when executed by the computer, cause the information processing device to:
in a case where the second program has been launched in response to the second launch instruction being received by the first program, and has received the printer identification information from the first program, search for the particular printing device using the printer identification information, and select the particular printing device in response to the particular printing device being found by the search.

14. The non-transitory computer-readable storage medium according to claim 13,
wherein the first program is further configured to, when executed by the computer, cause the information processing device to:
in the case where the first launch instruction has been received by the operating system with the particular printing device selected, acquire print setting information that indicates parameters included in print settings used for printing by the particular printing device; and
in said providing the launch instruction to launch the second program, pass the acquired printer identification information and the acquired print setting information, and
wherein the second program is further configured to, when executed by the computer, cause the information processing device to:
in a case where the second program has been launched in response to the second launch instruction being received by the first program, and has received the print setting information from the first program, perform a setting process to set the parameters of the print settings indicated by the print setting information as default values of the print settings.

15. The non-transitory computer-readable storage medium according to claim 14,
wherein the second program is further configured to, when executed by the computer, cause the information processing device to:
in the case where the second program has been launched in response to the second launch instruction being received by the first program, and has received the print setting information from the first program, receive a selection of whether to set the parameters of the print settings indicated by the print setting information provided by the first program, as the default values of the print settings, prior to the setting process to set the parameters of the print settings indicated by the print setting information as the default values of the print settings; and
perform corresponding processing depending on the received selection of whether to set the parameters of the print settings indicated by the print setting information as the default values of the print settings, thereby performing the setting process in response to receiving a selection of setting the parameters of the print settings indicated by the print setting information as the default values of the print settings, whereas not performing the setting process in response to receiving a selection of not setting the parameters of the print settings indicated by the print setting information as the default values of the print settings.

16. The non-transitory computer-readable storage medium according to claim 13,
wherein the second program is further configured to, when executed by the computer, cause the information processing device to:
in a case where the second program has been launched in response to the second launch instruction being received by the first program, and has received the printer identification information from the first program, search for the particular printing device using the printer identification information; and
perform corresponding processing depending on whether the particular printing device has been found by the search, thereby selecting the particular printing device in response to the particular printing device being found by the search, whereas providing a notification that the particular printing device is offline in response to the particular printing device not being found by the search.

17. A method implementable by a computer executing computer-readable instructions on an information processing device, the computer-readable instructions comprising a support program configured to support a generic print program standardly implemented with an operating system of the information processing device, the support program being configured to, when executed by the computer, cause the information processing device to perform the method, the method comprising:
in a case where a first launch instruction to launch the support program compatible with a particular printing device has been received by the operating system, acquiring printer identification information for identifying the particular printing device; and
in a case where a second launch instruction to launch a specific application program has been received via a user interface of the information processing device, providing the specific application program with a launch instruction to launch the specific application program and the acquired printer identification information, the specific application program being configured to receive selection of a printing device and receive a print instruction to cause the selected printing device to perform printing, the printer identification information being used for the specific application program to select the particular printing device.

18. The method according to claim 17, further comprising:
in a case where a print instruction to cause the particular printing device to print a target image has been output from an application program incorporated in the information processing device to the generic print program, acquiring image data representing the target image from the generic print program, and perform processing to send a print job based on the image data to the particular printing device.

19. The method according to claim 17,
wherein the generic print program is an IPP (Internet Printing Protocol) Class driver.
